(19) United States
(12) Patent Application Publication
(10) Pub. No.: US 2024/0405200 A1
(43) Pub. Date: Dec. 5, 2024

(54) Electrode Assembly, Lithium Secondary Battery Including Same, Method for Manufacturing Electrode Assembly, and Method for Managing Electrode Sliding Standard

(71) Applicant: LG Energy Solution, Ltd., Seoul (KR)

(72) Inventors: Seung Gi Yang, Daejeon (KR); Ung Ju Lee, Daejeon (KR); Dae Wook Kim, Daejeon (KR)

(73) Assignee: LG Energy Solution, Ltd., Seoul (KR)

(21) Appl. No.: 18/693,421

(22) PCT Filed: Aug. 3, 2023
(86) PCT No.: PCT/KR2023/011396

§ 371 Date: Mar. 19, 2024

(30) Foreign Application Priority Data
Aug. 8, 2022 (KR) 10-2022-0098524

(51) Int. Cl. H01M 4/36; H01M 4/02; H01M 10/052; H01M 10/0587; H01M 10/42

(52) U.S. Cl. CPC H01M 4/364; H01M 10/052; H01M 10/0587; H01M 10/42; H01M 2004/027; H01M 2004/028; H01M 2010/4292

(57) ABSTRACT

An electrode assembly including a negative electrode including a sliding region, wherein a first negative electrode thickness ratio of the thickness T_{N1} of the negative electrode mixture layer at the first face-to-face position where the negative electrode faces the lower end part of the positive electrode, to the thickness T_{NC} of the negative electrode mixture layer at the center part of the negative electrode, and a first positive electrode thickness ratio of the thickness T_{P1} of the positive electrode mixture layer at the lower end part of the positive electrode, to the thickness T_{PC} of the positive electrode mixture layer at the center part of the positive electrode satisfy the disclosed Condition 1 below. When the disclosed Condition 1 is satisfied, the risk of local NP ratio reversal in the sliding region can be effectively prevented.

### CROSS-REFERENCE TO RELATED APPLICATIONS

The present application is a national phase entry under 35 U.S.C. § 371 of International Application No. PCT/KR2023/011396, filed on Aug. 3, 2023, which claims priority from Korean Patent Application No. 10-2022-0098524, filed on Aug. 8, 2022, all the disclosures of which are incorporated herein by reference.

### TECHNICAL FIELD

The present disclosure relates to an electrode assembly for preventing lithium precipitation, a lithium secondary battery including the electrode assembly, a method for manufacturing the electrode assembly, and a method for managing an electrode sliding standards.

### BACKGROUND TECHNOLOGY OF THE INVENTION

The demand for batteries as an energy source is increasing rapidly due to technological development and increasing demand in industries such as mobile devices, automobiles, and energy storage. Among these secondary batteries, a lot of research has been done on lithium secondary batteries with high energy density and discharge voltage and are commercialized and widely used.

Depending on the shape of the battery case, secondary batteries are classified into cylindrical and prismatic batteries, where an electrode assembly is embedded in a cylindrical or prismatic metal can, and pouch-type batteries, where an electrode assembly is embedded in a pouch-type case made of aluminum laminated sheet.

Moreover, a jelly-roll type electrode assembly, wherein an electrode assembly embedded in a battery case, is a rechargeable power generator comprising a laminated structure of positive electrode/separator/negative electrode, wherein a separator is interposed between the positive electrode and the negative electrode of the long sheet type on which an electrode mixture including an electrode active material is applied and wound, a stack-type (laminated) electrode assembly in which a number of positive electrodes and negative electrodes punched and notched in predetermined sized units are stacked sequentially with a separator interposed between them, and a stack/folding-type electrode assembly having a structure in which bi-cells or full cells are wound by laminating predetermined units of positive electrode and negative electrode, and a separator interposed therebetween can be exemplified.

The positive electrode and negative electrode comprising the electrode assembly are manufactured by applying a slurry for electrode mixture manufactured in the mixing process to the electrode current collector in a predetermined pattern and a certain thickness through a slot die, and then drying it. However, since the electrode mixture slurry is a fluid, in the electrode mixture layer after the electrode mixture slurry application process, the electrode mixture slurry flows down due to its fluidity, which is called sliding.

FIG. 1 illustrates an electrode sheet with an electrode mixture applied to a sheet-type current collector, and FIG. 2 illustrates a cross-sectional view of the electrode sheet cut along a cutting-plane line (dashed line) in FIG. 1. Referring to these drawings, the electrode mixture applied part 2 on which the electrode mixture is applied gradually decreases in thickness along the direction toward the electrode mixture non-applied part 1 at both edges of the width direction x of the electrode sheet, forming an inclined surface in the plane of the current collector. This is referred to as a sliding region S. Such a sliding region may be formed within 30 mm, or within 20 mm, along the inward direction of the electrode mixture application part, from the boundary line between the electrode mixture non-applied part without the electrode mixture applied and the electrode mixture applied part with the electrode mixture applied.

Meanwhile, referring to FIG. 3, the positive electrode 10 and the negative electrode 20 comprising the electrode assembly are facing each other with a separator (not illustrated) interposed between them, and the length of the sliding region S of the positive electrode and the length of the sliding region S′ of the negative electrode may appear differently, and the inclined shape of the sliding region may appear variously, such as an upwardly convex shape, a downwardly convex shape, a straight shape, an S-shape, and the slope may appear differently even if the inclined shape is the same. As a result, depending on the facing position of the positive and negative electrodes, there may be a localized imbalance in the NP ratio, which may cause lithium to precipitate from the negative electrode and cause safety accidents such as short circuits.

Therefore, it is necessary to develop a technology to prevent an imbalance in the NP ratio in the process of manufacturing positive electrodes and negative electrodes, but conventionally, there have been limitations in managing the NP ratio in each unit process of the electrode slurry application process, drying and rolling process, and punching and notching process due to the cumbersome measurement of the thickness of the electrode mixture layer in the sliding region and the lack of a standardized method. Therefore, it is necessary to develop a technology for electrode assemblies that prevent localized NP ratio imbalance in the sliding region during electrode manufacturing, and management methods for electrode sliding standards to prevent NP ratio imbalance.

### DESCRIPTION OF THE INVENTION

### Technical Problem

A first problem that the technical ideas of the present disclosure seek to solve is to provide an electrode assembly, a secondary battery comprising the same, and a method of manufacturing the same, that prevents the risk of NP ratio reversal when at least one among the positive electrode and negative electrode includes a sliding region, even when the positive electrode and negative electrode are present in the same conventional face-to-face position.

A second problem that the technical ideas of the present disclosure seek to solve is to provide a standardized method of managing sliding standards to prevent the risk of reversal of the NP ratio in the manufacturing process of electrodes including sliding regions.

### Technical Solution

According to an exemplary embodiment of the present disclosure, an electrode assembly is provided. In the electrode assembly for a lithium secondary battery, a positive electrode and negative electrode are facing each other with a separator between them, but the protrusion direction of the positive electrode tab is opposite to the protrusion direction of the negative electrode tab, the negative electrode tab includes: a negative electrode shoulder line part in which a negative electrode mixture is applied on a negative electrode current collector and a negative electrode non-coated part in which a negative electrode mixture is not applied, the negative electrode shoulder line part includes: a negative electrode sliding region that forms an inclined plane to the negative electrode current collector plane as the thickness of the negative electrode mixture layer decreases along the protrusion direction of the negative electrode tab, wherein a first negative electrode thickness ratio RT_{N1}(=T_{N1}/T_{NC}), which is a ratio of the thickness T_{N1} of the negative electrode mixture layer at the first face-to-face position where the negative electrode faces the lower end part of the positive electrode, to the thickness T_{NC} of the negative electrode mixture layer at the center part of the negative electrode, and a first positive electrode thickness ratio RT_{P1}(=T_{P1}/T_{PC}), which is a ratio of the thickness T_{P1} of the positive electrode mixture layer at the lower end part of the positive electrode, to the thickness T_{PC} of the positive electrode mixture layer at the center part of the positive electrode may satisfy Condition 1 below.

$$R {T}_{N 1} \geq ( R {T}_{P 1} / NP Ratio ) \times 100.1 \qquad [ Condition 1 ]$$

(In condition 1, NP Ratio is a preset value, which means the ratio value of negative electrode capacity to positive electrode capacity per unit area)

In the electrode assembly according to an exemplary embodiment, a second negative electrode thickness ratio RT_{N2}(=T_{N2}/T_{NC}), which is a ratio of the thickness T_{N2} of the negative electrode mixture layer at the second face-to-face position where the negative electrode faces the upper end part of the positive electrode, to the thickness T_{NC} of the negative electrode mixture layer at the center part of the negative electrode, and a second positive electrode thickness ratio RT_{P2}(=T_{P2}/T_{PC}), which is a ratio of the thickness T_{P2} of the positive electrode mixture layer at the upper end part of the positive electrode, to the thickness T_{PC} of the positive electrode mixture layer at the center part of the positive electrode may satisfy Condition 2 below.

$$R {T}_{N 2} \geq ( R {T}_{P 2} / NP Ratio ) \times 100.1 \qquad [ Condition 2 ]$$

(In condition 2, NP Ratio is a preset value, which means the ratio value of negative electrode capacity to positive electrode capacity per unit area)

In the electrode assembly according to an exemplary embodiment, a ratio value of length L1 of the negative electrode shoulder line part, to a length L3, which is from the first face-to-face position to an end part of the negative electrode shoulder line part may be between 0.5 and 0.9.

In the electrode assembly according to an exemplary embodiment, the first positive electrode thickness ratio RT_{P1}(=T_{P1}/T_{PC}) may be from 0.6 to 1.

In the electrode assembly according to an exemplary embodiment, a positive electrode tab of the positive electrode includes a positive electrode shoulder line part with a positive electrode mixture applied on a positive electrode current collector, and a positive electrode non-coated part without a positive electrode mixture applied, and the positive electrode shoulder line part may include a positive electrode sliding region wherein the thickness of the positive electrode mixture layer decreases along the protrusion direction of a positive electrode tab, forming an inclined plane to a positive electrode current collector plane.

According to another exemplary embodiment of the present disclosure, a lithium secondary battery is provided, and the lithium secondary battery may include one or more of the electrode assemblies.

According to another exemplary embodiment of the present disclosure, a manufacturing method of the electrode assembly is provided. The manufacturing method of the electrode assembly includes: preparing an electrode sheet comprising, an electrode mixture applied part to which an electrode mixture is applied on an electrode current collector sheet, and an electrode mixture non-applied part to which an electrode mixture is not applied and is located at least at one edge of the electrode mixture applied part; a thickness measurement process including: measuring a thickness of each electrode mixture layer at a plurality of points selected at a boundary part of the electrode mixture applied part and electrode mixture non-applied part, and measuring a thickness of an electrode mixture layer at a center part of the electrode mixture applied part; calculating an electrode thickness ratio including: calculating a ratio of a thickness of an electrode mixture layer at each of the plurality of points, to a thickness of an electrode mixture layer at a center part of the electrode mixture applied part; setting up a positive/negative electrode notching predetermined line that sets a notching predetermined line notching in the form of individual positive electrodes and individual negative electrodes, on positive electrode sheets and negative electrode sheets, based on calculated positive electrode thickness ratio values and negative electrode thickness ratio values; a notching process that notches according to the set notching predetermined line; and a lamination process of laminating by interposing a separator between the notched positive electrode and negative electrode, wherein the positive/negative electrode notching predetermined line setting process includes: determining a positive electrode first face-to-face predetermined line P3 on a positive electrode sheet and determining a negative electrode face-to-face predetermined line P1 on a negative electrode sheet; determining the positive electrode first face-to-face predetermined line P3 as a positive electrode lower end part notching predetermined line; and determining a negative electrode upper end part notching predetermined line based on the negative electrode first face-to-face predetermined line P1, wherein the negative electrode first face-to-face predetermined line P1 and the positive electrode first face-to-face predetermined line P3 are determined such that a negative electrode thickness ratio at the negative electrode first face-to-face predetermined line P1 and a positive electrode thickness ratio at the positive electrode first face-to-face predetermined line P3 satisfy Condition 3 below.

$$Negative electrode thickness ratio \geq ( Positive electrode thickness ratio / NP Ratio ) \times 10 0.1 \qquad [ Condition 3 ]$$

(In condition 3, NP Ratio is a preset value, which means the ratio value of negative electrode capacity to positive electrode capacity per unit area)

In the electrode assembly manufacturing method according to an exemplary embodiment, the positive/negative electrode notching predetermined line setting process may further include: making a table of a combination of a positive electrode thickness ratio and a negative electrode thickness ratio satisfying Condition 3 according to a preset NP Ratio value.

In the electrode assembly manufacturing method according to an exemplary embodiment, in determining the negative electrode upper end part notching predetermined line, the negative electrode upper end part notching predetermined line may be determined as an imaginary line connecting points spaced apart by a planar spacing G1 of the positive electrode and negative electrode from the negative electrode first face-to-face predetermined line along a width direction of the negative electrode sheet.

In the electrode assembly manufacturing method according to an exemplary embodiment, the positive/negative electrode notching predetermined line setting process may further include: determining a positive electrode second face-to-face predetermined line P4 in the positive electrode sheet, and determining a negative electrode second face-to-face predetermined line P2 in the negative electrode sheet, wherein the negative electrode second face-to-face predetermined line P2 and the positive electrode second face-to-face predetermined line P4 are determined such that a negative electrode thickness ratio at the negative electrode second face-to-face predetermined line P2 and a positive electrode thickness ratio at the positive electrode second face-to-face predetermined line P4 satisfy Condition 3.

In the electrode assembly manufacturing method according to an exemplary embodiment, the negative electrode second face-to-face predetermined line P2 may be determined as an imaginary line connecting points spaced apart by a full-length direction length C of the positive electrode from the negative electrode first face-to-face predetermined line P1 along a width direction of the negative electrode sheet.

In the electrode assembly manufacturing method according to an exemplary embodiment, the positive/negative electrode notching predetermined line setting process may further include: determining the positive electrode second face-to-face predetermined line P4 as a positive electrode upper end part predetermined line; and determining an imaginary line connecting points spaced apart by a full-length direction length A of the negative electrode along a width direction of the negative electrode sheet from the negative electrode upper end part notching predetermined line, as a negative electrode lower end part notching predetermined line.

In the electrode assembly manufacturing method according to an exemplary embodiment, the positive/negative electrode notching predetermined line setting process may further include determining a positive electrode tab notching predetermined line and a negative electrode tab notching predetermined line, wherein in determining a positive electrode tab notching predetermined line and a negative electrode tab notching predetermined line, a positive electrode tab notching predetermination line is set such that the positive electrode tab includes a positive electrode shoulder line part with a positive electrode mixture applied thereto, and a negative electrode tab notching predetermination line is set such that the negative electrode tab includes a negative electrode shoulder line part with a negative electrode mixture applied thereto.

In the electrode assembly manufacturing method according to an exemplary embodiment, the lamination process may include laminating a positive electrode such that a positive electrode lower end part notching predetermined line of the notched positive electrode is located on a first face-to-face predetermined line of the notched negative electrode.

In the electrode assembly manufacturing method according to an exemplary embodiment, the lamination process may include laminating a positive electrode such that a positive electrode upper end part notching predetermined line of the notched positive electrode is located on a second face-to-face predetermined line of the notched negative electrode.

According to another exemplary embodiment of the present disclosure, a management method of an electrode sliding standard is provided. The electrode sliding standards management method is a method of managing an electrode sliding standards of electrode including a sliding region in which a thickness of an electrode mixture layer gradually decreases to form an inclined plane with respect to a current collector plane, including: measuring the thickness TPC of a positive electrode mixture layer at the center part of the positive electrode, and the thickness TP1 of the positive electrode mixture layer at the lower end part predetermined area of the positive electrode, on the positive electrode sheet, respectively, and calculating the first positive electrode thickness ratio RT_{P1}(=T_{P1}/T_{PC}), which is the ratio of T_{P1} to T_{PC}; determining a negative electrode first face-to-face predetermined line P1 on the negative electrode sheet to face the positive electrode lower end part predetermined area; measuring a thickness T_{NC} of the negative electrode mixture layer at the center part of the negative electrode and a thickness T_{N1} of the negative electrode mixture layer at the negative electrode first face-to-face predetermined line P1, on the negative electrode sheet, respectively, and calculating the first negative electrode thickness ratio RT_{N1}(=T_{N1}/T_{NC}), which is the ratio of T_{N1} to T_{NC}; and confirming whether a relationship between the first positive electrode thickness ratio RT_{P1} and the first negative electrode thickness ratio RT_{N1} satisfies Condition 1 below.

$$R {T}_{N 1} \geq ( R {T}_{P 1} / NP Ratio ) \times 100.1 \qquad [ Condition 1 ]$$

(In condition 1, NP Ratio is a preset value, which means the ratio value of negative electrode capacity to positive electrode capacity per unit area)

In the electrode sliding standards management method according to an exemplary embodiment, it may further include: measuring the thickness T_{P2} of the positive electrode mixture layer at the positive electrode upper end part predetermined area, and calculating the second positive electrode thickness ratio RT_{P2}(=T_{P2}/T_{PC}), which is the ratio of T_{P2} to T_{PC}; determining a negative electrode second face-to-face predetermined line P2 to face the positive electrode upper end part in the negative electrode sheet; measuring the thickness T_{N2} of the negative electrode mixture layer at the second negative electrode face-to-face predetermined line P2, and calculating the second negative electrode thickness ratio RT_{N2}(=T_{N2}/T_{NC}), which is the ratio of T_{N2} to T_{NC}; and determining whether a relationship between the second positive electrode thickness ratio RT_{P2} and the second negative electrode thickness ratio RT_{N2} satisfies Condition 2 below.

$$R {T}_{N 2} \geq ( R {T}_{P 2} / NP Ratio ) \times 100.1 \qquad [ Condition 2 ]$$

(In condition 2, NP Ratio is a preset value, which means the ratio value of negative electrode capacity to positive electrode capacity per unit area)

In the electrode sliding standards management method according to an exemplary embodiment, in determining the negative electrode first face-to-face predetermined line, the negative electrode first face-to-face predetermined line P1 may be determined as an imaginary line connecting points spaced apart by a length L1 of the negative electrode shoulder line part and a planar spacing G1 of the positive electrode and negative electrode along the width direction from the boundary line of the negative electrode mixture applied part and the negative electrode mixture non-applied part.

In the electrode sliding standards management method according to an exemplary embodiment, in determining the negative electrode second face-to-face predetermined line, the negative electrode second face-to-face predetermined line P2 may be determined as an imaginary line connecting points spaced apart by a full-length direction length C of the positive electrode along a width direction from the negative electrode first face-to-face predetermined line P1.

### Advantageous Effects

The electrode assembly and the method of manufacturing the electrode assembly according to exemplary embodiments of the present disclosure have the effect of preventing the phenomenon of a localized reversal of the NP ratio in the electrode sliding region.

According to exemplary embodiments of the present disclosure, the positive electrode thickness ratio and the negative electrode thickness ratio calculated at a specific face-to-face position where the positive electrode and the negative electrode face each other satisfy predetermined conditions to ensure prevention of a localized NP Ratio reversal risk, and the sliding region where the NP Ratio reversal risk exists can be managed in a standardized way.

### BRIEF DESCRIPTION OF THE DRAWINGS

FIG. 1 is a top view of an electrode sheet with an electrode mixture applied on a current collector.

FIG. 2 is a cross-sectional view of an electrode sheet cut along the cut line (dotted line) in FIG. 1.

FIG. 3 is a conceptual diagram to illustrate the concept of an imbalance in the NP ratio in the electrode sliding region.

FIG. 4 is a cross-sectional view of an electrode assembly according to an exemplary embodiment of the present disclosure.

FIG. 5 is a cross-sectional view of the electrode assembly enlarged at portion A of FIG. 4.

FIG. 6 is a top view of portion A of FIG. 4.

FIG. 7 is a cross-sectional view of the electrode assembly enlarged at portion B of FIG. 4.

FIG. 8 is a top view of portion B of FIG. 4.

FIGS. 9 and 10 are flowcharts to illustrate a method of manufacturing an electrode assembly according to an exemplary embodiment of the present disclosure.

FIG. 11 is a drawing to illustrate a method of manufacturing an electrode assembly according to an exemplary embodiment of the present disclosure.

FIG. 12 is a flowchart to illustrate a method for managing electrode sliding standards according to an exemplary embodiment of the present disclosure.

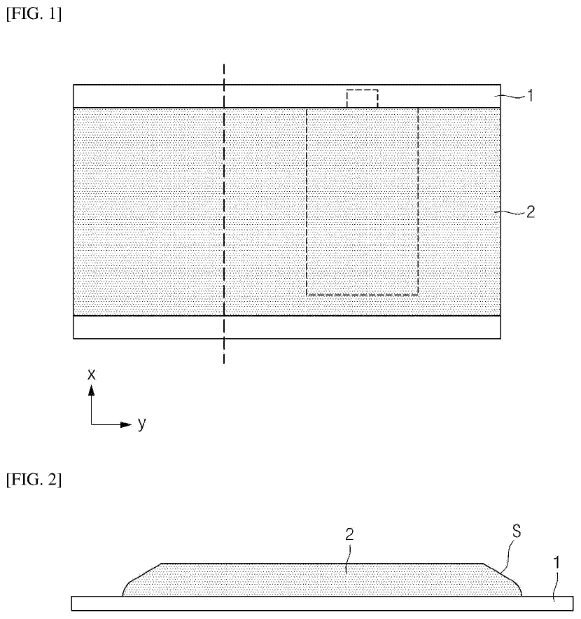

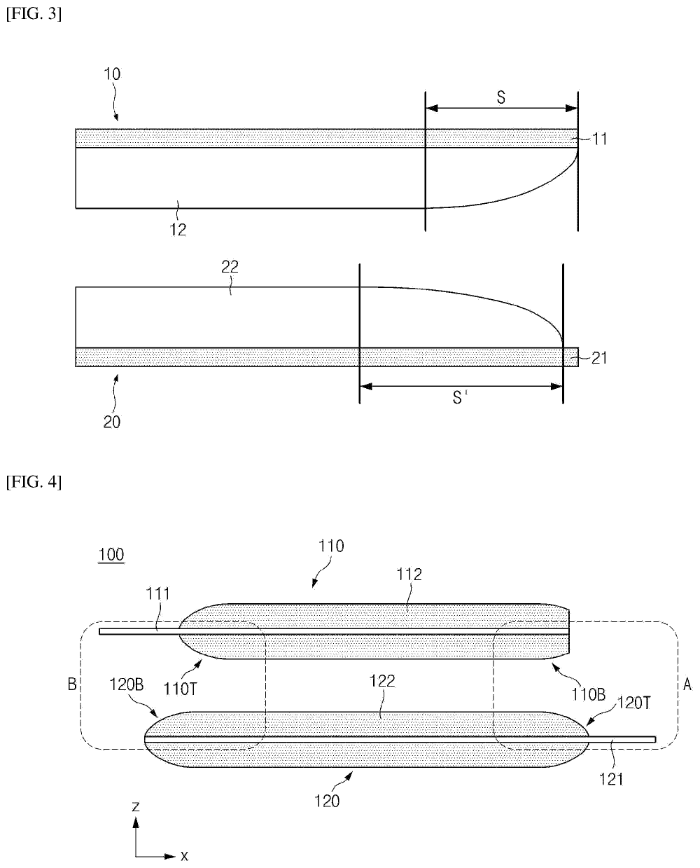

### REFERENCE NUMERALS

10: POSITIVE ELECTRODE SHEET
11: POSITIVE ELECTRODE MIXTURE NON-APPLIED PART
12: POSITIVE ELECTRODE MIXTURE APPLIED PART
20: NEGATIVE ELECTRODE SHEET
21: NEGATIVE ELECTRODE MIXTURE NON-APPLIED PART
22: NEGATIVE ELECTRODE MIXTURE APPLIED PART
100: ELECTRODE ASSEMBLY
110: POSITIVE ELECTRODE, POSITIVE ELECTRODE NOTCHING PREDETERMINED LINE
120: NEGATIVE ELECTRODE, NEGATIVE ELECTRODE NOTCHING PREDETERMINED LINE
111: POSITIVE ELECTRODE TAB
121: NEGATIVE ELECTRODE TAB
111A: POSITIVE ELECTRODE SHOULDER LINE PART
111B: POSITIVE ELECTRODE NON-COATED PART
121a: NEGATIVE ELECTRODE SHOULDER LINE PART
121b: NEGATIVE ELECTRODE NON-COATED PART
P1: NEGATIVE ELECTRODE FIRST FACE-TO-FACE PREDETERMINED LINE
P2: NEGATIVE ELECTRODE SECOND FACE-TO-FACE PREDETERMINED LINE
P3: POSITIVE ELECTRODE FIRST FACE-TO-FACE PREDETERMINED LINE
P4: POSITIVE ELECTRODE SECOND FACE-TO-FACE PREDETERMINED LINE

### BEST MODE FOR CARRYING OUT THE INVENTION

The following is a detailed description of the present invention. It should be noted that the terms or words used in this specification and the claims of the patent are not to be construed in their ordinary or dictionary sense, but rather in a sense and concept consistent with the technical idea of the present invention, based on the principle that the inventor may properly define the concept of a term to best describe his invention.

The terms “comprise,” “include” and “have” are used herein to designate the presence of characteristics, numbers, steps, actions, components or members described in the specification or a combination thereof, and it should be understood that the possibility of the presence or addition of one or more other characteristics, numbers, steps, actions, components, members or a combination thereof is not excluded in advance. In addition, when a part of a layer, a film, a region or a plate is disposed “on” another part, this includes not only a case in which one part is disposed “directly on” another part, but a case in which a third part is interposed there between. In contrast, when a part of a layer, a film, a region or a plate is disposed “under” another part, this includes not only a case in which one part is disposed “directly under” another part, but a case in which a third part is interposed there between. In addition, in this application, “on” may include not only a case of disposed on an upper part but also a case of disposed on a lower part.

In this specification, NP Ratio is a preset value, meaning the ratio of the negative electrode capacity to the positive electrode capacity per unit area. It may be determined according to the specifications of the product, and the NP Ratio has a value of 100% or more, and the unit of % is omitted in conditions 1 to 3. The specific numerical range of the NP Ratio may be, for example, 100 or more and 200 or less, 100 or more and 180 or less, 100 or more and 160 or less, 101 to 140.

In this specification, a sliding region refers to a region around the boundary of an electrode mixture non-applied part where no electrode mixture (positive electrode mixture layer and negative electrode mixture layer) has been applied and an electrode mixture applied part where electrode mixture has been applied, where the thickness of the electrode mixture layer is not constant and gradually decreases as it approaches the electrode mixture non-applied part, forming an inclined plane with respect to the current collector plane.

In this specification, a positive electrode upper end part refers to the end of the positive electrode corner part from which the positive electrode tab protrudes, and a negative electrode upper end part refers to the end of the negative electrode corner part from which the negative electrode tab protrudes.

In this specification, a positive electrode lower end part refers to the end of the positive electrode corner part opposite the positive electrode corner part from which the positive electrode tab protrudes, and a negative electrode lower end part refers to the end of the negative electrode corner part opposite the negative electrode corner part from which the negative electrode tab protrudes.

In this specification, the center part of the negative electrode (positive electrode), which is a region excluding the sliding region, is a broad concept referring to a region of the negative electrode (positive electrode) mixture layer in which the thickness of the negative electrode (positive electrode) mixture layer is constant and unchanged as it is parallel to the plane of the current collector, and does not necessarily refer to a specific point in the center part of the full-length direction (x) of the negative electrode (positive electrode).

In this specification, the width direction of the electrode sheet and the full-length direction of the electrode are defined as the y-axis direction, the transfer direction (MD) of the electrode sheet and the full-width direction of the electrode are defined as the x-axis direction, and the thickness direction of the electrode and the thickness direction of the electrode assembly are defined as the z-axis direction.

### First Embodiment

The present disclosure provides an electrode assembly as a first embodiment.

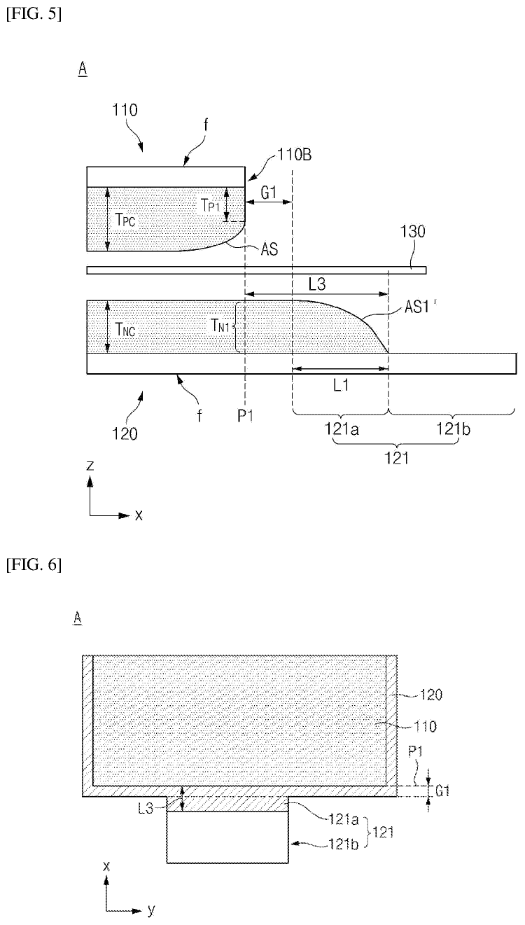

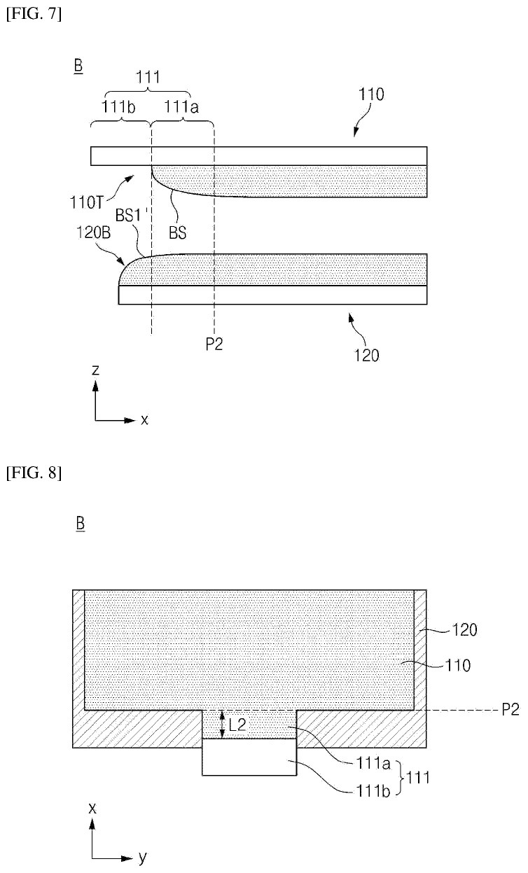

FIG. 4 is a cross-sectional view of an electrode assembly according to an exemplary embodiment of the present disclosure, FIG. 5 is a cross-sectional view of an electrode assembly enlarged at portion A of FIG. 4, FIG. 6 is a top view of portion A of FIG. 4, FIG. 7 is a cross-sectional view of an electrode assembly enlarged at portion B of FIG. 4, and FIG. 8 is a top view of portion B of FIG. 4.

Referring to these drawings, an electrode assembly 100 for a lithium secondary battery according to an exemplary embodiment of the present disclosure includes a positive electrode 110 and a negative electrode 120 facing each other with a separator 130 between them, wherein a protrusion direction of a positive electrode tab 111 and a protrusion direction of a negative electrode tab 121 are mutually opposite, and the negative electrode tab 121 includes a negative electrode shoulder line part 121a with a negative electrode mixture applied thereto and a negative electrode non-coated part 121b without a negative electrode mixture applied thereto, wherein the negative electrode shoulder line part 121a includes a negative electrode sliding region S′ forming an inclined plane on the plane of the negative electrode current collector, with the thickness of the negative electrode mixture layer 122 decreasing along the protrusion direction of the negative electrode tab 121.

In general, electrode assemblies for lithium secondary batteries are managed to have an NP ratio of 1 or more to prevent lithium from precipitating during charge and discharge and to prevent rapid degradation of the battery, especially during high-rate charge and discharge. However, when the positive electrode and negative electrode include a sliding region, depending on the length of the sliding region, the inclined shape of the sliding (S-shaped or straight), and the slope, there may be a reversal of the NP ratio such that the NP ratio is less than 1 locally. Especially in the sliding region of the negative electrode, the risk of reversal of the NP ratio may be greater due to the relatively small thickness of the negative electrode mixture layer.

According to an exemplary embodiment of the disclosure, when notching the negative electrode from the negative electrode sheet, the negative electrode is manufactured by notching such that the negative electrode shoulder line part is included within the negative electrode tab. This means that the negative electrode sliding region is cut off when the negative electrode is notched. Accordingly, the length of the sliding region of the negative electrode mixture layer around the negative electrode upper end part 120T according to the present disclosure is shortened compared to the length of the sliding region of the negative electrode according to the prior art in which the negative electrode is notched so that the negative electrode shoulder line part is not present within the negative electrode tab. Therefore, the electrode assembly according to the present disclosure can reduce the risk of NP ratio reversal due to the shortened length of the sliding region of the negative electrode. Here, the length of the negative electrode sliding region refers to the length by which the negative electrode sliding region extends along the full-length direction (x-axis direction) of the negative electrode.

Referring to FIG. 4, in the electrode assembly 100, a area A where the lower end part 110B of the positive electrode and the upper end part 120T of the negative electrode from which the negative electrode tab 121 protrudes are facing each other, and a area B where the upper end part 110T of the positive electrode and the lower end part 120B of the negative electrode are facing each other are regions where the NP ratio reversal is likely to occur. And, among the facing areas A and B, the NP ratio reversal is more likely to occur in the facing area A where the lower end part of the positive electrode 110B and the upper end part of the negative electrode 120T are facing each other.

Referring to FIGS. 5 and 7, the length of the negative electrode sliding region AS′ at the facing area A is longer than the length of the negative electrode sliding region BS′ at the facing area B. This is because when the negative electrode sheet, which is the base material of the negative electrode, is notched into individual negative electrodes, the negative electrode shoulder line part located within the negative electrode tab includes the sliding region as it is, but the sliding region at the lower end part of the negative electrode is partially cut off. On the other hand, the length of the positive electrode sliding region AS at the facing area A is shorter than the length of the positive electrode sliding region BS at the facing area B. As a result, the negative electrode with a relatively long sliding region and the positive electrode with a relatively short sliding region are facing each other at facing area A. Therefore, the reversal of the NP ratio is more likely to occur at facing area A.

Accordingly, the electrode assembly according to an exemplary embodiment of the present disclosure is characterized in that it is designed to preferentially satisfy the following Condition 1 at facing area A. Specifically, the electrode assembly 100 according to an exemplary embodiment has a first negative electrode thickness ratio RT_{N1}(=T_{N1}/T_{NC}), which is a ratio of the thickness T_{N1} of the negative electrode mixture layer at the first face-to-face position where the negative electrode faces the lower end part of the positive electrode, to the thickness T_{NC} of the negative electrode mixture layer at the center part of the negative electrode, and a first positive electrode thickness ratio RT_{P1}(=T_{P1}/T_{PC}), which is a ratio of the thickness T_{P1} of the positive electrode mixture layer at the lower end part of the positive electrode, to the thickness T_{PC} of the positive electrode mixture layer at the center part of the positive electrode may satisfy Condition 1 below.

$$R {T}_{N 1} \geq ( R {T}_{P 1} / NP Ratio ) \times 100.1 \qquad [ Condition 1 ]$$

(In condition 1, NP Ratio is a preset value, which means the ratio value of negative electrode capacity to positive electrode capacity per unit area)

The positive electrode and negative electrode are facing each other with a separator between them, and in order for the NP ratio inversion not to occur, the capacity of the negative electrode must be greater than the capacity of the positive electrode facing it. However, since it is difficult to measure the capacity of the positive electrode in the sliding region of the positive electrode and the capacity of the negative electrode in the sliding region of the negative electrode, respectively, it is easy to manage the NP Ratio by measuring the thickness of the positive electrode mixture layer and the thickness of the negative electrode mixture layer, respectively, instead of the capacity in the sliding region. This is because the capacity of the electrode is proportional to the thickness of the electrode mixture layer.

Even so, it is not practical to apply the method of managing the NP ratio to the mass production process by measuring the thickness of the positive electrode mixture layer and the thickness of the negative electrode mixture layer at all areas where the positive electrode and negative electrode face each other, respectively, and checking whether the NP ratio is met based on the measurements.

Therefore, in order to present an electrode assembly model in which NP ratio reversal does not occur, the present disclosure does not need to measure the thickness of the electrode mixture layer at all areas where the positive electrode and the negative electrode face each other, but calculate each value of the first negative electrode thickness ratio and the first positive electrode thickness ratio from the thickness of the positive electrode mixture layer and the thickness of the negative electrode mixture layer measured at a specific face-to-face position, thereby ensuring that the electrode assembly whose relationship satisfies Condition 1 does not have NP ratio reversal. And, the first face-to-face position P1, which is a thickness measurement position for calculating the thickness ratio, is specified as a position facing the lower end part 110 of the positive electrode in the negative electrode 120, and is specified as the lower end part 110B of the positive electrode in the case of the positive electrode 110, respectively.

In other words, the electrode assembly according to the present disclosure is an electrode assembly designed using a thickness ratio at the “first face-to-face position P1” where the positive electrode lower end part 110B and the negative electrode 120 face each other, and the risk of NP ratio reversal is prevented.

In the present disclosure, the NP Ratio is managed using the thickness ratio rather than the absolute value of the thickness, because the thickness ratio can further ensure the prevention of the risk of NP Ratio reversal. While the thickness of the positive electrode mixture layer or the thickness of the negative electrode mixture layer measured at a specific face-to-face position cannot determine the degree of sliding, the positive electrode thickness ratio or the negative electrode thickness ratio at a specific face-to-face position can determine the degree of sliding, so the method of managing the NP Ratio using the thickness ratio can further ensure the prevention of the risk of NP Ratio reversal.

In one particular example, the first positive electrode thickness ratio RT_{P1}(=T_{P1}/T_{PC}) may be from 0.6 to 1, and more particularly may be from 0.65 to 0.99; from 0.7 to 0.98; from 0.75 to 0.95; from 0.8 to 0.95. As for the lower end part 110B of the positive electrode at the facing area A, it is desirable to minimize the sliding region to increase the energy density of the positive electrode, and accordingly, the thickness ratio of the lower end part of the positive electrode, the first positive electrode thickness ratio, has the above numerical range.

Referring to FIG. 6, in one particular example, a ratio value of a length L1 of the negative electrode shoulder line part 121a, to a length L3, which is from the first face-to-face position P1 to an end part of the negative electrode shoulder line part, may be 0.5 to 0.9, and more specifically may be 0.65 to 0.8; 0.6 to 0.9; 0.7 to 0.9; 0.7 to 0.8. In terms of preventing NP ratio reversal, it is preferred that the negative electrode shoulder line part has a long length.

The electrode assembly 100 according to an exemplary embodiment of the present disclosure has a second negative electrode thickness ratio RT_{N2}(=T_{N2}/T_{NC}), which is a ratio of the thickness T_{N2} of the negative electrode mixture layer at the second face-to-face position where the negative electrode faces the upper end part of the positive electrode, to the thickness T_{NC} of the negative electrode mixture layer at the center part of the negative electrode, and a second positive electrode thickness ratio RT_{P2}(=T_{P2}/T_{PC}), which is a ratio of the thickness T_{P2} of the positive electrode mixture layer at the upper end part of the positive electrode, to the thickness T_{PC} of the positive electrode mixture layer at the center part of the positive electrode may satisfy Condition 2 below.

$$R {T}_{N 2} \geq ( R {T}_{P 2} / NP Ratio ) \times 100.1 \qquad [ Condition 2 ]$$

(In condition 2, NP Ratio is a preset value, which means the ratio value of negative electrode capacity to positive electrode capacity per unit area) Condition 2 above may be a condition to ensure that the risk of NP Ratio reversal at the facing area B is prevented. As described above, the probability of NP Ratio reversal at the facing area B is smaller than that at the facing area A, so the Condition 2 may be meaningful as an auxiliary measure of NP Ratio management.

Referring to FIGS. 7 and 8, the facing area B is an area where the positive electrode upper end part 110T and the negative electrode lower end part 120B face each other, and the positive electrode tab 111 may include a positive electrode shoulder line part 111a to which an positive electrode mixture 112 is applied on the current collector, and a positive electrode non-coated part 111b to which no positive electrode mixture is applied, wherein the positive electrode shoulder line part 111a may include a positive electrode sliding region S forming an inclined plane on the plane of the positive electrode current collector, with the thickness of the positive electrode mixture layer 112 decreasing along the protrusion direction of the positive electrode tab 111.

### Second Embodiment

In a second embodiment, the present disclosure provides a method of manufacturing an electrode assembly.

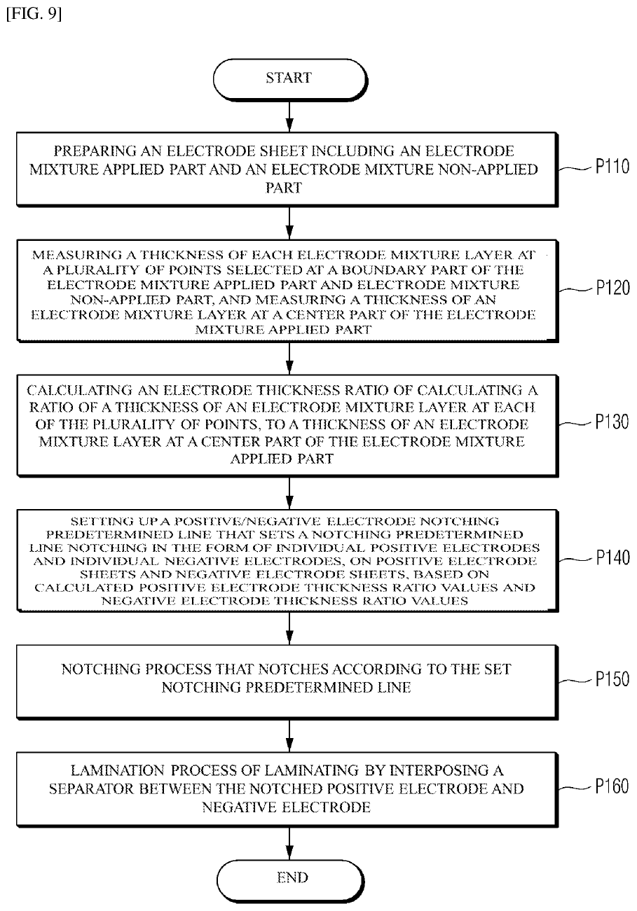

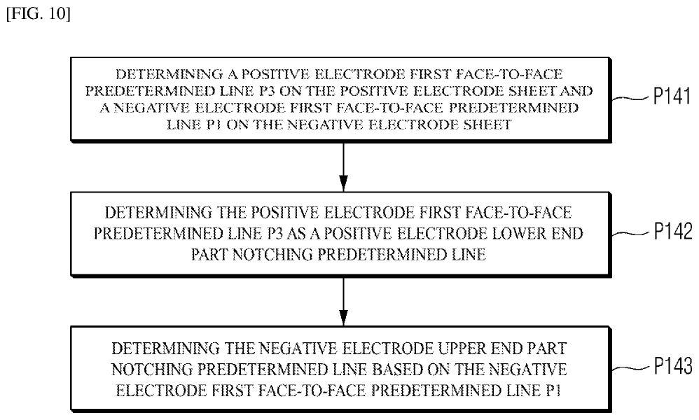

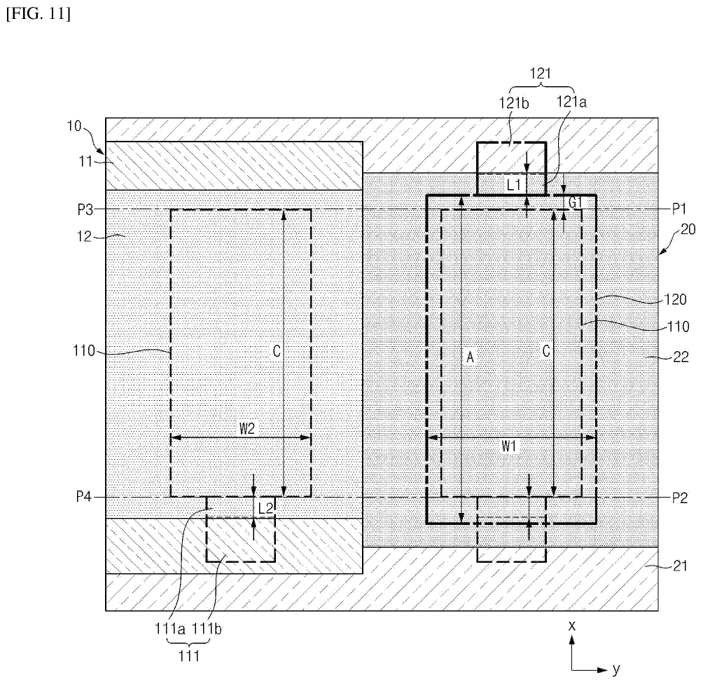

FIGS. 9 and 10 are flowcharts to illustrate a method of manufacturing an electrode assembly according to an exemplary embodiment of the present disclosure, and FIG. 11 is a drawing to illustrate a method of manufacturing an electrode assembly according to an exemplary embodiment of the present disclosure.

Referring to FIG. 9, a method of manufacturing an electrode assembly according to exemplary embodiments of the present disclosure includes: preparing an electrode sheet including an electrode mixture applied part and an electrode mixture non-applied part P110; measuring a thickness of each electrode mixture layer at a plurality of points selected at a boundary part of the electrode mixture applied part and electrode mixture non-applied part, and measuring a thickness of an electrode mixture layer at a center part of the electrode mixture applied part P120; calculating an electrode thickness ratio by calculating a ratio of a thickness of an electrode mixture layer at each of the plurality of points, to a thickness of an electrode mixture layer at a center part of the electrode mixture applied part P130; setting up a positive/negative electrode notching predetermined line that sets a notching predetermined line notching in the form of individual positive electrodes and individual negative electrodes, on positive electrode sheets and negative electrode sheets, based on calculated positive electrode thickness ratio values and negative electrode thickness ratio values P140; a notching process that notches according to the set notching predetermined line P150; and a lamination process of laminating by interposing a separator between the notched positive electrode and negative electrode, P160.

According to an exemplary embodiment of the present disclosure, prior to setting a notching predetermined line for the positive and negative electrodes, a plurality of points are selected at the boundary between the electrode mixture applied part and the electrode mixture non-applied part, and the thickness of the electrode mixture layer is measured at the selected plurality of points, and the respective thickness ratio at the selected plurality of points is calculated. Then, based on the calculated plurality of thickness ratio values, the electrode assembly is designed, so a localized NP ratio reversal in the electrode sliding region may be prevented.

Preparing the electrode sheet P110 may be a process of preparing an electrode sheet including, an electrode mixture applied part to which an electrode mixture is applied on an electrode current collector sheet, and an electrode mixture non-applied part to which an electrode mixture is not applied and is located at least at one edge of the electrode mixture applied part.

Specifically, the electrode sheet preparation process P110 may include preparing a negative electrode sheet and preparing a positive electrode sheet. The process of preparing these electrode sheets may be prepared by applying an electrode slurry including an electrode active material to a sheet-type current collector, and then drying and rolling.

Referring to FIG. 11, the negative electrode sheet 20 may include a negative electrode mixture applied part 22 with a negative electrode mixture applied thereto and a negative electrode mixture non-applied part 21 without a negative electrode mixture applied thereto. The negative electrode mixture non-applied part 21 may be located at either edge of the negative electrode mixture applied part relative to the width direction (x-axis direction) of the negative electrode sheet. However, it is not limited to this, and the negative electrode mixture non-applied part 21 may be located at one edge of the negative electrode mixture applied part 22. The positive electrode sheet 10, like the negative electrode sheet 20, also includes a positive electrode mixture applied part 12 with a positive electrode mixture applied thereto and a positive electrode mixture non-applied part 11 without a positive electrode mixture applied thereto, wherein the positive electrode mixture non-applied part 11 may be each located at either edge of the positive electrode mixture applied part 12, or may be located at one edge of the positive electrode mixture applied part 12.

The thickness measurement process P120 may include selecting a plurality of points at the boundary of the electrode mixture applied part and non-applied part, measuring the thickness of each electrode mixture layer at the selected points, and measuring the thickness of the electrode mixture layer at a center part of the electrode mixture applied part. Here, the boundary between the electrode mixture applied part and non-applied part may be a region where a sliding region exists.

The thickness measurement process P120 may include measuring a thickness of a positive electrode mixture layer on the positive electrode sheet and measuring a thickness of a negative electrode mixture layer on the negative electrode sheet.

Specifically, the process of measuring the thickness of the positive electrode mixture layer in the positive electrode sheet may include a process of measuring the thickness of the positive electrode mixture layer in the center part of the positive electrode sheet 10, and a process of randomly selecting a plurality of points in the area around the boundary of the positive electrode mixture applied part 12 and the positive electrode mixture non-applied part 21 including the sliding region in the positive electrode sheet 10, and measuring the thickness of each of the positive electrode mixture layers at those points. Here, the plurality of points may be selected at regular spacings along the width direction (x-axis direction) of the positive electrode sheet 10.

Furthermore, the process of measuring the thickness of the negative electrode mixture layer in the negative electrode sheet may include a process of measuring the thickness of the negative electrode mixture layer in the center part of the negative electrode sheet 20, and a process of randomly selecting a plurality of points in the region around the boundary of the negative electrode mixture applied part 22 and the negative electrode mixture non-applied part 21 including the sliding region in the negative electrode sheet 20, and measuring the thickness of each negative electrode mixture layer at those points. Here, the plurality of points may be selected at regular spacings along the width direction (x-axis direction) of the negative electrode sheet 20.

After the thickness measurement process P120, the thickness ratio calculation process P130 is performed. The thickness ratio calculation process may include a positive electrode thickness ratio calculation process and a negative electrode thickness ratio calculation process.

The positive electrode thickness ratio may be defined as a ratio value of the thickness of each positive electrode mixture layer at the plurality of points to the thickness T_{PC} of the positive electrode mixture layer at the center part of the positive electrode composite application portion, and the negative electrode thickness ratio may be defined as a ratio value of the thickness of each negative electrode mixture layer at the plurality of points to the thickness T_{NC} of the negative electrode mixture layer at the center part of the negative electrode mixture applied part. Thus, according to the thickness ratio calculation process P130, the respective positive electrode thickness ratio of the plurality of points and the respective negative electrode thickness ratio of the plurality of points may be calculated.

Setting the notching predetermined lines of the positive/negative electrode P140 may be a process of setting the positive electrode notching predetermined line to be notched in the form of individual positive electrodes 110 on the positive electrode sheet 10 and the negative electrode notching predetermined lines to be notched in the form of individual negative electrodes 120 on the negative electrode sheet 20, based on the positive electrode thickness ratio and the negative electrode thickness ratio calculated in above electrode thickness ratio calculation process P130.

In setting the notching predetermined line of the positive/negative electrode, since it is prior to laminating the positive electrode, negative electrode, and separator, it is not determined which part of the positive electrode sheet and which part of the negative electrode sheet are to be faced, and in such a state, it is not known whether the relationship between the negative electrode thickness ratio and the positive electrode thickness ratio satisfies Condition 3. Therefore, the process of setting the notching predetermined line of the positive/negative electrode P140 may include determining a part of the positive electrode sheet to be faced with the negative electrode, and determining a part of the negative electrode sheet to be faced with the positive electrode.

Referring to FIGS. 4 through 5 and FIG. 11, with reference to the x-axis direction, an upper part of the positive electrode sheet 10 may be notched with a positive electrode lower end part 110B, and a lower part of the positive electrode sheet 10 may be notched with a positive electrode tab 111 and a positive electrode upper end part 110T. In addition, the positive electrode lower end part 110B and the positive electrode upper end part 110T may be specific face-to-face positions of the positive electrode according to the present disclosure. That is, the positive electrode lower end part predetermined line may be a positive electrode first face-to-face predetermined line P3, and the positive electrode upper end part predetermined line may be a positive electrode second face-to-face predetermined line P4.

The positive electrode upper end part refers to the end of the positive electrode corner part with the positive electrode tab protruding, and the positive electrode lower end part refers to the end of the positive electrode corner part opposite the positive electrode corner part with the positive electrode tab protruding.

According to the present disclosure, the electrode assembly may be designed so that each positive electrode thickness ratio on the positive electrode first face-to-face predetermined line P3 and the positive electrode second face-to-face predetermined line P4 satisfies Condition 3. That is, among the plurality of positive electrode thickness ratio values calculated in the thickness ratio calculation process P130, a point having a positive electrode thickness ratio satisfying Condition 3 may be located on the positive electrode first face-to-face predetermined line P3 and the positive electrode second face-to-face predetermined line P4.

Referring to FIGS. 6 through 7 and FIG. 11, the negative electrode 120 is generally cut larger than the positive electrode 110, so that when the positive electrode 110 is superimposed on the negative electrode 120, a portion of the negative electrode 110 is visible around the periphery of the positive electrode 110. Based to the x-axis direction, an upper part of the negative electrode sheet 20 may be notched with a negative electrode tab 121 and a negative electrode upper end part 120T, and a lower part of the negative electrode sheet 20 may be notched with a negative electrode lower end part 120B. Then, a negative electrode first face-to-face predetermined line P1 may be set at the upper part of the negative electrode sheet 20, and a negative electrode second face-to-face predetermined line P2 may be set at the lower part of the negative electrode sheet 20.

Here, the upper end part of the negative electrode refers to the end of the negative electrode corner part from which the negative electrode tab protrudes, and the lower end part of the negative electrode refers to the end of the negative electrode corner part opposite the negative electrode corner part from which the negative electrode tab protrudes.

According to the present disclosure, the electrode assembly may be designed so that each negative electrode thickness ratio on the negative electrode first face-to-face predetermined line P1 and the negative electrode second face-to-face predetermined line P2 satisfies Condition 3. That is, among the plurality of negative electrode thickness ratio values calculated in the thickness ratio calculation process P130, a point having a negative electrode thickness ratio satisfying Condition 3 may be located on the negative electrode first face-to-face predetermined line P1 and the negative electrode second face-to-face predetermined line P2.

In the electrode assembly 100 assembled by the lamination process P160, the negative electrode first face-to-face predetermined line P1 and the positive electrode first face-to-face predetermined line P3 may be overlapped relative to the horizontal direction (x-y) of the electrode assembly. And the negative electrode second face-to-face predetermined line P2 and the positive electrode second face-to-face predetermined line P4 may be overlapped relative to the horizontal direction (x-y) of the electrode assembly.

Referring to FIGS. 10 and 11, the process of setting the positive and negative notching predetermined lines P140 according to an exemplary embodiment may include: determining a positive electrode first face-to-face predetermined line P3 on the positive electrode sheet 10 and a negative electrode first face-to-face predetermined line P1 on the negative electrode sheet 20 P141; determining the positive electrode first face-to-face predetermined line P3 as a positive electrode lower end part notching predetermined line P142; and determining a notching predetermined line of the negative electrode upper end part based on the negative electrode first face-to-face predetermined line P1, wherein the negative electrode first face-to-face predetermined line P1 and the positive electrode first face-to-face predetermined line P3 are determined such that the negative electrode thickness ratio at the negative electrode first face-to-face predetermined line P1 and the positive electrode thickness ratio at the positive electrode first face-to-face predetermined line P3 satisfy Condition 3 below.

$$Negative electrode thickness ratio \geq ( Positive electrode thickness ratio / NP Ratio ) \times 10 0.1 \qquad [ Condition 3 ]$$

(In condition 3, NP Ratio is a preset value, which means the ratio value of negative electrode capacity to positive electrode capacity per unit area)

In other words, among the plurality of negative electrode thickness ratio values, a point having a negative electrode thickness ratio satisfying Condition 3 may be determined as the negative electrode first face-to-face predetermined line P1, and among the plurality of positive electrode thickness ratio values, a point having an positive electrode thickness ratio satisfying Condition 3 may be determined as the positive electrode first face-to-face predetermined line P3.

Condition 3 is a criterion for ensuring prevention of NP Ratio reversal of the positive/negative electrodes in the sliding region, and the electrode assembly manufacturing method according to an exemplary embodiment of the present disclosure can set a notching predetermined line for the positive/negative electrodes based on a specific facing position satisfying Condition 3, and can ensure prevention of NP Ratio reversal by laminating the positive/negative electrodes. And, the electrode assembly manufactured accordingly can ensure prevention of NP Ratio reversal at facing area A where the lower end part 110B of the positive electrode and the upper end part 120T of the negative electrode from which the negative electrode tab 121 protrudes are facing.

According to an exemplary embodiment of the present disclosure, the process of setting the positive/negative notching predetermined line P140 may further include a process of making a table of a combination of positive electrode thickness ratio and negative electrode thickness ratio satisfying Condition 3 according to a preset NP Ratio value. In this case, it has the effect of facilitating determination of the positive electrode first and second face-to-face predetermined lines and the negative electrode first and second face-to-face predetermined lines satisfying Condition 3.

For example, if the NP Ratio is set to 108, a combination of the positive electrode thickness ratio and the negative electrode thickness ratio that satisfies Condition 3 can be generated as shown in Table 1. Then, according to the combination in Table 1, the positive electrode first and second face-to-face predetermined lines P3,P4 and the negative electrode first and second face-to-face predetermined lines P1,P2 that are the basis for the notching predetermined line can be determined.

TABLE 1

| Positive electrode | Negative electrode |
|---|---|
| Thickness Ratio | Thickness Ratio |
| 1 or less | 0.93 or more |
| 0.95 or less | 0.88 or more |
| 0.90 or less | 0.83 or more |
| 0.85 or less | 0.79 or more |
| 0.80 or less | 0.74 or more |
| 0.75 or less | 0.70 or more |
| 0.70 or less | 0.65 or more |
| 0.65or less | 0.60 or more |
| 0.60 or less | 0.56 or more |

Referring to FIG. 11, in the negative electrode sheet 20, the notching predetermined line (dotted line of 120) of the negative electrode may be set larger than the size of the positive electrode (dotted line of 110) to be notched. And the notching predetermined line of the negative electrode tab may be located on one side of the negative electrode mixture applied part 22. And, a notching predetermined line of the negative electrode may be determined according to a length L1 of the negative electrode shoulder line part, a length A of the negative electrode in the full-length direction (x-axis direction), and a length W1 of the negative electrode in the full-width direction (y-axis direction).

In an exemplary embodiment, the full-length direction length A of the negative electrode and the width direction length W1 of the negative electrode may be preset lengths, and in determining the length L1 of the negative electrode shoulder line part 121a included within the negative electrode tab region, the length L1 of the negative electrode shoulder line part may be naturally determined based on the negative electrode first face-to-face predetermined line P1 satisfying Condition 3. Here, the length of the negative electrode shoulder line part may be defined as an extended length of the negative electrode shoulder line part 121a to which the negative electrode mixture is applied, in the negative electrode tab predetermined area.

Referring to FIG. 11, in the process of determining the notching predetermined line of the upper end part of the negative electrode P143, the notching predetermined line of the upper part of the negative electrode may be determined as an imaginary line connecting points spaced apart by a planar spacing G1 of the positive electrode and the negative electrode from the negative electrode first face-to-face predetermined line P1 along the width direction (x-axis direction) of the negative electrode sheet.

Referring to FIGS. 10 and 11, the positive electrode notching predetermined line 110 in the positive electrode sheet 10 may be set smaller than the size of the negative electrode 120 to be notched. And, the notching predetermined line of the positive electrode may be set such that a positive electrode tab 111 is formed on one side of the positive electrode mixture applied part 12. And, the notching predetermined line of the positive electrode may be determined according to a length L2 of the positive electrode shoulder line part, a length C of the full-length direction (x-axis direction) of the positive electrode, and a length W2 of the full-width direction (y-axis direction) of the positive electrode.

In an exemplary embodiment, the length C of the positive electrode in the full-length direction and the length W2 of the positive electrode in the full-width direction may be preset lengths, and in determining the length L2 of the positive electrode shoulder line part 111b included within the positive electrode tab region, the length L2 of the positive electrode shoulder line part may be naturally determined based on the positive electrode second face-to-face predetermined line P4 satisfying Condition 3.

According to an exemplary embodiment, the process of setting the positive/negative notching predetermined line P140 may further include determining a positive electrode second face-to-face predetermined line P4 on the positive electrode sheet and determining a negative electrode second face-to-face predetermined line P2 on the negative electrode sheet. At this time, the negative electrode second face-to-face predetermined line P2 and the positive electrode second face-to-face predetermined line P4 may be determined such that a negative electrode thickness ratio at the negative electrode second face-to-face predetermined line P2 and a positive electrode thickness ratio at the positive electrode second face-to-face predetermined line P4 satisfy Condition 3.

The electrode assembly manufactured accordingly can ensure prevention of NP Ratio reversal at the facing area B where the upper end part 110T of the positive electrode and the lower end part 120B of the negative electrode are facing each other. However, as described above, the likelihood of an NP Ratio reversal occurring is higher at the aforementioned facing area A than at the facing area B, so the process P144 of determining the second face-to-face predetermined line P2 may have the meaning of assisting the process of determining the first face-to-face predetermined line P1.

Referring to FIG. 11, the negative electrode second face-to-face predetermined line P2 may be determined as an imaginary line connecting points spaced apart by a full-length direction length C of the positive electrode from the negative electrode first face-to-face predetermined line P1 along the width direction of the negative electrode sheet.

In an exemplary embodiment, the process of setting the positive/negative electrodes notching predetermination line P140 may further include: determining a notching predetermination line for the positive electrode upper end part P145; and determining a notching predetermination line for the negative electrode lower end part P146.

Referring to FIG. 11, the notching predetermined line of the positive electrode upper end part may be determined as the positive electrode second face-to-face predetermined line P4, and the notching predetermined line of the negative electrode lower end part may be determined as an imaginary line connecting points spaced apart from the notching predetermined line of the negative electrode upper end part by a full-length direction length A along the width direction of the negative electrode sheet.

In an exemplary embodiment, the process of setting the positive/negative electrodes notching predetermined lines may further include a process of determining a positive electrode tab notching predetermined line and a negative electrode tab notching predetermined line P147. Referring to FIG. 11, the process of determining the positive electrode tab notching predetermined line and negative electrode tab notching predetermined line may be to set the positive electrode tab notching predetermined line to include a positive electrode shoulder line part 111a with a positive electrode mixture applied within the positive electrode tab 111, and to set the negative electrode tab notching predetermined line to include a negative electrode shoulder line part 121a with a negative electrode mixture applied within the negative electrode tab 121.

Specifically, the negative electrode shoulder line part 121a of the negative electrode tab 121 may be included in an inner region of the negative electrode tab 121 in a form extending from an imaginary line connecting points spaced apart by a predetermined positive electrode and negative electrode planar spacing G1 from the negative electrode first face-to-face predetermined line P1 toward the negative electrode tab non-coated part 121b. And, the boundary line of the negative electrode shoulder line part 121a and the negative electrode non-coated part 121b may coincide with the boundary line of the negative electrode mixture applied part 22 and the negative electrode mixture non-applied part 21 of the negative electrode sheet 20, which is the base material of the negative electrode 120.

In addition, the shoulder line part 111a of the positive electrode tab 111 may be included in an inner region of the positive electrode tab 111 in a form extending from the positive electrode second face-to-face predetermined line P4 toward the positive electrode tab non-coated part 111b. And the boundary line of the positive electrode shoulder line part 111a and the positive electrode non-coated part 111b may coincide with the boundary line of the positive electrode mixture applied part 12 and the positive electrode mixture non-applied part 11 of the positive electrode sheet 10, which is the base material of the positive electrode 110.

The notching process P150 may include a positive electrode notching process, wherein the positive electrode sheet 10 is notched along a notching predetermined line of the positive electrode established according to the above process to obtain an individual positive electrode 110, and a negative electrode notching process, wherein the negative electrode sheet is notched along a notching predetermined line of the negative electrode established according to the above process to obtain an individual negative electrode 120.

The lamination process P160 may be a process of laminating by interposing a separator between the notched positive electrode and negative electrode.

The lamination process P160 may include laminating the positive electrode such that a positive electrode lower end part notching predetermined line of the notched positive electrode 110 is positioned on a first face-to-face notching predetermined line P1 of the notched negative electrode 120.

Furthermore, the lamination process P160 may include laminating the positive electrode such that a positive electrode upper end part notching predetermined line of the notched positive electrode 110 is positioned on a second face-to-face notching predetermined line P2 of the positive electrode of the notched negative electrode 120.

An electrode assembly manufacturing method according to exemplary embodiments of the present disclosure can manage electrode sliding standards in a standardized way by using a specific face-to-face position of the positive and negative electrodes and an electrode thickness ratio on an electrode sheet including a sliding region. In addition, management of the NP Ratio reversal of the electrode sliding region can be performed more simply, thereby improving production efficiency.

### Third Embodiment

The present disclosure provides a lithium secondary battery in a third embodiment. The lithium secondary battery according to exemplary embodiments of the present disclosure may include a single electrode assembly, or may include a stacked body with a plurality of stacked electrode assemblies.

According to an exemplary embodiment, the electrode assembly is an electrode assembly for a lithium secondary battery having a positive electrode and a negative electrode facing each other with a separator between them, wherein the protrusion direction of the positive electrode tab and the protrusion direction of the negative electrode tab are mutually opposite, wherein the negative electrode tab includes a negative electrode shoulder line part to which a negative electrode mixture is applied on the negative electrode current collector and a negative electrode non-coated part to which no negative electrode mixture is applied, wherein negative electrode shoulder line part includes a negative electrode sliding region forming an inclined plane to the negative electrode current collector plane as the thickness of the negative electrode mixture layer decreases along the protrusion direction of the negative electrode tab, wherein a first negative electrode thickness ratio RT_{N1}(=T_{N1}/T_{NC}), which is a ratio of the thickness T_{N1} of the negative electrode mixture layer at the first face-to-face position where the negative electrode faces the lower end part of the positive electrode, to the thickness T_{NC} of the negative electrode mixture layer at the center part of the negative electrode, and a first positive electrode thickness ratio RT_{P1}(=T_{P1}/T_{PC}), which is a ratio of the thickness T_{P1} of the positive electrode mixture layer at the lower end part of the positive electrode, to the thickness T_{PC} of the positive electrode mixture layer at the center part of the positive electrode may satisfy Condition 1 below.

$$R {T}_{N 1} \geq ( R {T}_{P 1} / NP Ratio ) \times 100.1 \qquad [ Condition 1 ]$$

(In condition 1, NP Ratio is a preset value, which means the ratio value of negative electrode capacity to positive electrode capacity per unit area)

### Fourth Embodiment

The present disclosure provides a method for managing electrode sliding standards in a fourth embodiment.

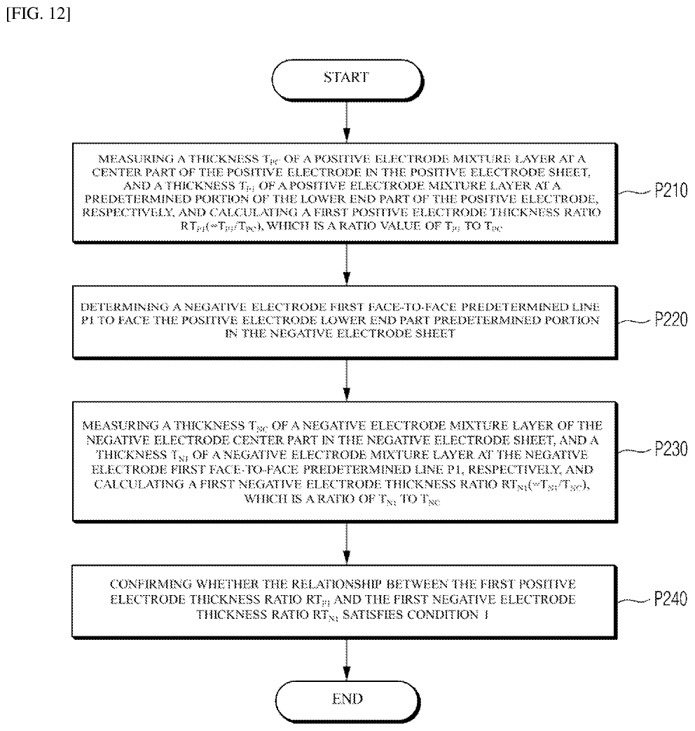

FIG. 12 is a flowchart to illustrate a method for managing electrode sliding standards according to an exemplary embodiment of the present disclosure.

Referring to FIG. 12, a method of managing an electrode sliding standards according to an exemplary embodiment of the present disclosure is a method of managing an electrode sliding standards of electrode including a sliding region in which the thickness of the positive electrode mixture layer gradually decreases to form an inclined plane with respect to a current collector plane, including: measuring a thickness T_{PC} of a positive electrode mixture layer at a center part of the positive electrode in the positive electrode sheet, and a thickness T_{P1} of a positive electrode mixture layer at a predetermined portion of the lower end part of the positive electrode, respectively, and calculating a first positive electrode thickness ratio RT_{P1}(=T_{P1}/T_{PC}), which is a ratio value of T_{P1} to T_{PC}, P210; determining a negative electrode first face-to-face predetermined line P1 to face the positive electrode lower end part predetermined portion in the negative electrode sheet P220; measuring a thickness T_{NC} of a negative electrode mixture layer of the negative electrode center part in the negative electrode sheet, and a thickness T_{N1} of a negative electrode mixture layer at the negative electrode first face-to-face predetermined line P1, respectively, and calculating a first negative electrode thickness ratio RT_{N1}(=T_{N1}/T_{NC}), which is a ratio of T_{N1} to T_{NC}, P230; and confirming whether the relationship between the first positive electrode thickness ratio RT_{P1} and the first negative electrode thickness ratio RT_{N1} satisfies Condition 1 P240.

$$R {T}_{N 1} \geq ( R {T}_{P 1} / NP Ratio ) \times 100.1 \qquad [ Condition 1 ]$$

(In condition 1, NP Ratio is a preset value, which means the ratio value of negative electrode capacity to positive electrode capacity per unit area)

A method of managing an electrode sliding standards according to an exemplary embodiment may further include: measuring a thickness T_{P2} of a positive electrode mixture layer at a predetermined portion of the positive electrode upper end part, and calculating a second positive electrode thickness ratio RT_{P2}(=T_{P2}/T_{PC}), which is a ratio of T_{P2} to T_{PC}; determining a negative electrode second predetermined line P2 to face the positive electrode upper end part in the negative electrode sheet; measuring a thickness T_{N2} of the negative electrode mixture layer at the second negative electrode face-to-face line P2, and calculating a second negative electrode thickness ratio RT_{N2}(=T_{N2}/T_{NC}), which is a ratio of T_{N2} to T_{NC}; and confirming whether the relationship between the second positive electrode thickness ratio RT_{P2} and the second negative electrode thickness ratio RT_{N2} satisfies Condition 2 below.

$$R {T}_{N 2} \geq ( R {T}_{P 2} / NP Ratio ) \times 100.1 \qquad [ Condition 2 ]$$

(In condition 2, NP Ratio is a preset value, which means the ratio value of negative electrode capacity to positive electrode capacity per unit area)

Referring to FIG. 11, in the process of determining the negative electrode first face-to-face predetermined line according to an exemplary embodiment, the negative electrode first face-to-face predetermined line P1 may be determined as an imaginary line connecting points spaced apart from the boundary line of the negative electrode mixture applied part and the negative electrode mixture non-applied part by a length L1 of the negative electrode shoulder line part plus a planar spacing G1 of the positive electrode and negative electrode along the width direction.

In addition, in the process of determining the negative electrode second face-to-face predetermined line according to an exemplary embodiment, the negative electrode second face-to-face predetermined line P2 may be determined as an imaginary line connecting points spaced apart by a full-length direction length C of the positive electrode from the negative electrode first face-to-face predetermined line P1 along the width direction.

A method of managing electrode sliding standards according to exemplary embodiments of the present disclosure can manage electrode sliding standards in a standardized manner using a specific face-to-face position of the positive/negative electrodes and an electrode thickness ratio in an electrode sheet including a sliding region.

Hereinafter, the present invention is described with reference to examples in accordance with the present invention, but only for a better understanding of the present invention, and the scope of the present invention is not limited thereto.

### Example 1

A slurry for a negative electrode including artificial graphite, SBR binder, CMC viscosity agent, and carbon black is applied on copper foil, and a dried and rolled negative electrode sheet was prepared. A slurry for a positive electrode including LiNi_{0.8}Co_{0.1}Mn_{0.1}O₂, PVDF binder, and carbon black is applied on aluminum foil, and a dried and rolled positive electrode sheet was prepared.

A positive electrode full-length direction length, positive electrode full-width direction length, negative electrode full-length direction length, negative electrode full-width direction length, and planar spacing G1 of the upper end part of the negative electrode and the lower end part of the positive electrode are set so that the NP Ratio of the electrode assembly to be assembled is 108.

On the prepared negative electrode sheet, a plurality of measurement locations was randomly selected at the boundary of the negative electrode mixture applied part and negative electrode mixture non-applied part, and the thickness of each negative electrode mixture layer was measured at the selected plurality of points. And, the thickness of the negative electrode mixture layer in the center part of the negative electrode mixture applied part was also measured. Then, the negative electrode thickness ratio values, which are the ratio of the thickness of the negative electrode mixture layer at each of the plurality of points to the thickness of the negative electrode mixture layer in the negative electrode center part, were calculated.

For the prepared positive electrode sheets, same as the negative electrode sheets, the thickness of the positive electrode mixture layer was measured and the positive electrode thickness ratio values were calculated.

On the negative electrode sheet, a negative electrode first face-to-face predetermined line P1 with a negative electrode thickness ratio of 0.94 was determined, and on the positive electrode sheet, a positive electrode first face-to-face predetermined line P3 with a positive electrode thickness ratio of 0.99 was determined. Then, on the negative electrode sheet, a negative electrode second face-to-face predetermined line P2 with a negative electrode thickness ratio of 0.96 was determined, and on the positive electrode sheet, a positive electrode second face-to-face predetermined line P4 with a positive electrode thickness ratio of 0.94 was determined.

An imaginary line connecting the points spaced apart by a preset planar spacing G1 of the positive electrode and negative electrode from the negative electrode first face-to-face predetermined line P1 was determined as the notching predetermined line of the negative electrode upper end part. Then, an imaginary line connecting the points spaced apart by a preset full-length direction length A of the negative electrode from the negative electrode upper end part notching predetermined line was determined as the notching predetermined line of the negative electrode lower end part. Then, the positive electrode first face-to-face predetermined line P3 was determined as the notching predetermined line of the positive electrode lower end part, and the positive electrode second face-to-face predetermined line P4 was determined as the notching predetermined line of the positive electrode upper end part.

The electrode assembly manufacture was completed by notching the positive electrode and negative electrode along the notching predetermined line set above, and laminating the positive electrode so that the positive electrode lower end part notching predetermined line of the notched positive electrode is located on the negative electrode first face-to-face predetermined line P1 of the notched negative electrode, and the positive electrode upper end part notching predetermined line of the notched positive electrode 110 is located on the negative electrode second face-to-face predetermined line P2 of the notched negative electrode.

### Example 2

In Example 1, when determining the negative electrode first and second predetermined lines and the positive electrode first and second predetermined lines, a negative electrode first face-to-face predetermined line P1 with a negative electrode thickness ratio of 0.89 was determined in the negative electrode sheet, and a positive electrode first face-to-face predetermined line P3 with a positive electrode thickness ratio of 0.94 was determined in the positive electrode sheet. Then, in the negative electrode sheet, a negative electrode second face-to-face predetermined line P2 with a negative electrode thickness ratio of 0.93 was determined, and in the positive electrode sheet, a positive electrode second face-to-face predetermined line P4 with a positive electrode thickness ratio of 0.90 was determined. Except for this, the electrode assembly was prepared by the same method as in Example 1.

### Comparative Example 1

In Example 1, when determining the negative electrode first and second predetermined lines and the positive electrode first and second predetermined lines, a negative electrode first face-to-face predetermined line P1 with a negative electrode thickness ratio of 0.90 was determined in the negative electrode sheet, and a positive electrode first face-to-face predetermined line P3 with a positive electrode thickness ratio of 0.99 was determined in the positive electrode sheet. Then, in the negative electrode sheet, a negative electrode second face-to-face predetermined line P2 with a negative electrode thickness ratio of 0.85 was determined, and in the positive electrode sheet, a positive electrode second face-to-face predetermined line P4 with a positive electrode thickness ratio of 0.94 was determined. Except for this, the electrode assembly was prepared by the same method as in Example 1.

### Comparative Example 2

In Example 1, when determining the negative electrode first and second predetermined lines and the positive electrode first and second predetermined lines, a negative electrode first face-to-face predetermined line P1 with a negative electrode thickness ratio of 0.80 was determined in the negative electrode sheet, and a positive electrode first face-to-face predetermined line P3 with a positive electrode thickness ratio of 0.94 was determined in the positive electrode sheet. Then, in the negative electrode sheet, a negative electrode second face-to-face predetermined line P2 with a negative electrode thickness ratio of 0.82 was determined, and in the positive electrode sheet, a positive electrode second face-to-face predetermined line P4 with a positive electrode thickness ratio of 0.90 was determined. Except for this, the electrode assembly was prepared by the same method as in Example 1.

Experimental Example: Observing Lithium Precipitation

Each of the electrode assemblies of the Examples and the Comparative Examples was stored in a pouch-type battery case made of a PP/Al/nylon laminated sheet, sealed by injecting an electrolyte, and an activation process was performed to manufacture a secondary battery.

After the manufactured secondary battery was subjected to 200 cycles of charge and discharge, the battery was disassembled to visually check whether lithium was precipitated from the negative electrode, and the results are shown in Table 1. In Table 1, Conditions 1, 2, and 3 are as described above, and “O” means that the condition is met or lithium is precipitated, and “X” means that the condition is not met or lithium is not precipitated.

TABLE 2

| | Whether | Whether | Whether | Whether |
|---|---|---|---|---|
| | Condition 1 | Condition 2 | Condition 3 | lithium |
| | is satisfied | is satisfied | is satisfied | precipitated |
| Example 1 | ◯ | ◯ | ◯ | X |
| Example 2 | ◯ | ◯ | ◯ | X |
| Comparative | X | X | X | ◯ |
| Example 1 | | | | |
| Comparative | X | X | X | ◯ |
| Example 2 | | | | |

As shown above, the electrode assembly manufactured by the method according to the example of the present disclosure satisfied Conditions 1, 2, and 3 and did not precipitate lithium from the negative electrode after 200 cycles of charge and discharge. On the other hand, lithium precipitation was observed in the secondary battery including the electrode assembly of the comparative example after 200 cycles of charge and discharge.

As described above, according to the present disclosure, by specifying a face-to-face position having a positive/negative electrode thickness ratio satisfying Condition 1 to Condition 3 and setting a notching predetermined line based on it, it is possible to easily prevent a local reversal of the NP ratio without changing the spacing of the preset positive/negative electrodes.

1. An electrode assembly for a lithium secondary battery, comprising:
a positive electrode having a positive electrode tab and a negative electrode having a negative electrode tab,
wherein the positive electrode and the negative electrode are positioned to face each other, with a separator disposed between them, and
a protrusion direction of the positive electrode tab is opposite to a protrusion direction of the negative electrode tab;
wherein the negative electrode tab comprises: a negative electrode shoulder line part in which a negative electrode mixture is applied on a negative electrode current collector and a negative electrode non-coated part in which a negative electrode mixture is not applied;
wherein the negative electrode shoulder line part comprises: a negative electrode sliding region that forms an inclined plane to a plane of the negative electrode current collector as a thickness of the negative electrode mixture layer decreases along the protrusion direction of the negative electrode tab;
wherein
a first negative electrode thickness ratio RT_{N1}(=T_{N1}/T_{NC}) and a first positive electrode thickness ratio RT_{P1}(=T_{P1}/T_{PC}) satisfy Condition 1 below;
wherein the first negative electrode thickness ratio is a ratio of a thickness T_{N1} of a negative electrode mixture layer at a first face-to-face position where the negative electrode faces a lower end part of the positive electrode, to a thickness T_{NC} of the negative electrode mixture layer at a center part of the negative electrode, and
wherein the first positive electrode thickness ratio is a ratio of a thickness T_{P1} of a positive electrode mixture layer at the lower end part of the positive electrode, to a thickness T_{PC} of the positive electrode mixture layer at a center part of the positive electrode;
$$R {T}_{N 1} \geq ( R {T}_{P 1} / NP Ratio ) \times 100.1 \qquad [ Condition 1 ]$$
wherein in the Condition 1, the NP Ratio is a ratio value of negative electrode capacity to positive electrode capacity per unit area, and is a preset value.

2. The electrode assembly of claim 1, wherein
a second negative electrode thickness ratio RT_{N2}(=T_{N2}/T_{NC}) and a second positive electrode thickness ratio RT_{P2}(=T_{P2}/T_{PC}) satisfy Condition 2 below,
wherein the second negative electrode thickness ratio is a ratio of a thickness T_{N2} of the negative electrode mixture layer at the second face-to-face position where the negative electrode faces an upper end part of the positive electrode, to the thickness T_{NC} of the negative electrode mixture layer at the center part of the negative electrode, and
wherein the second positive electrode thickness ratio is a ratio of a thickness T_{P2} of the positive electrode mixture layer at the upper end part of the positive electrode, to the thickness T_{PC} of the positive electrode mixture layer at the center part of the positive electrode;
$$R {T}_{N 2} \geq ( R {T}_{P 2} / NP Ratio ) \times 100.1 \qquad [ Condition 2 ]$$
wherein in the Condition 2, the NP Ratio is a ratio value of negative electrode capacity to positive electrode capacity per unit area, and is a preset value.

3. The electrode assembly of claim 1, wherein
a ratio value of length L1 of the negative electrode shoulder line part, to a length L3, which is from the first face-to-face position to an end part of the negative electrode shoulder line part, is between 0.5 and 0.9.

4. The electrode assembly of claim 1, wherein the first positive electrode thickness ratio RT_{P1}(=T_{P1}/T_{PC}) is from 0.6 to 1.

5. The electrode assembly of claim 2,
wherein the positive electrode tab of the positive electrode comprises a positive electrode shoulder line part with a positive electrode mixture applied on a positive electrode current collector, and a positive electrode non-coated part without a positive electrode mixture applied, and
wherein the positive electrode shoulder line part comprises a positive electrode sliding region wherein the thickness of the positive electrode mixture layer decreases along the protrusion direction of the positive electrode tab, forming an inclined plane to a plane of the positive electrode current collector.

6. A lithium secondary battery comprising one or more electrode assemblies according to claim 1 and an electrolyte.

7. An electrode assembly manufacturing method comprising:
preparing an electrode sheet comprising: an electrode mixture applied part to which an electrode mixture is applied on an electrode current collector sheet, and an electrode mixture non-applied part to which an electrode mixture is not applied and is located at least at one edge of the electrode mixture applied part;
performing a thickness measurement process comprising: measuring a thickness of each electrode mixture layer at a plurality of points selected at a boundary part of the electrode mixture applied part and the electrode mixture non-applied part, and measuring a thickness of an electrode mixture layer at a center part of the electrode mixture applied part;
calculating an electrode thickness ratio comprising: calculating a ratio of a thickness of an electrode mixture layer at each of the plurality of points, to a thickness of an electrode mixture layer at a center part of the electrode mixture applied part;
setting up a positive/negative electrode notching predetermined line that sets a notching predetermined line notching in the form of individual positive electrodes and individual negative electrodes, on positive electrode sheets and negative electrode sheets, based on calculated positive electrode thickness ratio values and negative electrode thickness ratio values;
performing a notching process that notches according to the set notching predetermined line; and
performing a lamination process of laminating by interposing a separator between the notched positive electrode and negative electrode,
wherein
the positive/negative electrode notching predetermined line setting process comprises:
determining a positive electrode first face-to-face predetermined line P3 on the positive electrode sheet and determining a negative electrode face-to-face predetermined line P1 on the negative electrode sheet;
determining the positive electrode first face-to-face predetermined line P3 as a positive electrode lower end part notching predetermined line; and
determining a negative electrode upper end part notching predetermined line based on the negative electrode first face-to-face predetermined line P1,
wherein
the negative electrode first face-to-face predetermined line P1 and the positive electrode first face-to-face predetermined line P3 are determined such that a negative electrode thickness ratio at the negative electrode first face-to-face predetermined line P1 and a positive electrode thickness ratio at the positive electrode first face-to-face predetermined line P3 satisfy Condition 3 below;
Negative electrode thickness ratio≥(Positive electrode thickness ratio/NP Ratio)×100.1 [Condition 3]
wherein in the Condition 3, the NP Ratio is a ratio value of negative electrode capacity to positive electrode capacity per unit area, and is a preset value.

8. The electrode assembly manufacturing method of claim 7,
wherein
the positive/negative electrode notching predetermined line setting process further comprises:
making a table of a combination of a positive electrode thickness ratio and a negative electrode thickness ratio satisfying the Condition 3 according to a preset NP Ratio value.

9. The electrode assembly manufacturing method of claim 7,
wherein,
in determining the negative electrode upper end part notching predetermined line,
the negative electrode upper end part notching predetermined line is determined as an imaginary line connecting points spaced apart by a planar spacing G1 of the positive electrode and negative electrode from the negative electrode first face-to-face predetermined line along a width direction of the negative electrode sheet.

10. The electrode assembly manufacturing method of claim 7,
wherein
the positive/negative electrode notching predetermined line setting process further comprises:
determining a positive electrode second face-to-face predetermined line P4 in the positive electrode sheet, and determining a negative electrode second face-to-face predetermined line P2 in the negative electrode sheet,
wherein
the negative electrode second face-to-face predetermined line P2 and the positive electrode second face-to-face predetermined line P4 are determined such that a negative electrode thickness ratio at the negative electrode second face-to-face predetermined line P2 and a positive electrode thickness ratio at the positive electrode second face-to-face predetermined line P4 satisfy the Condition 3.

11. The electrode assembly manufacturing method of claim 10,
wherein
the negative electrode second face-to-face predetermined line P2 is determined as an imaginary line connecting points spaced apart by a full-length direction length C of the positive electrode from the negative electrode first face-to-face predetermined line P1 along a width direction of the negative electrode sheet.

12. The electrode assembly manufacturing method of claim 10,
wherein
the positive/negative electrode notching predetermined line setting process further comprises:
determining the positive electrode second face-to-face predetermined line P4 as a positive electrode upper end part predetermined line; and
determining an imaginary line connecting points spaced apart by a full-length direction length A of the negative electrode along a width direction of the negative electrode sheet from the negative electrode upper end part notching predetermined line, as a negative electrode lower end part notching predetermined line.

13. The electrode assembly manufacturing method of claim 7,
wherein
the positive/negative electrode notching predetermined line setting process further comprises determining a positive electrode tab notching predetermined line and a negative electrode tab notching predetermined line,
wherein,
in determining the positive electrode tab notching predetermined line and the negative electrode tab notching predetermined line,
the positive electrode tab notching predetermination line is set such that the positive electrode tab includes a positive electrode shoulder line part with a positive electrode mixture applied thereto, and the negative electrode tab notching predetermination line is set such that the negative electrode tab includes a negative electrode shoulder line part with a negative electrode mixture applied thereto.

14. The electrode assembly manufacturing method of claim 7, wherein the lamination process comprises laminating a positive electrode such that a positive electrode lower end part notching predetermined line of the notched positive electrode is located on a first face-to-face predetermined line of the notched negative electrode.

15. The electrode assembly manufacturing method of claim 7, wherein the lamination process comprises laminating a positive electrode such that a positive electrode upper end part notching predetermined line of the notched positive electrode is located on a second face-to-face predetermined line of the notched negative electrode.

16. A method of managing sliding standards of an electrode including a sliding region in which a thickness of an electrode mixture layer gradually decreases to form an inclined plane with respect to a current collector plane, the method comprising:
measuring a thickness T_{PC} of a positive electrode mixture layer at the center part of a positive electrode, and a thickness T_{P1} of the positive electrode mixture layer at a lower end part predetermined area of the positive electrode, on a positive electrode sheet, respectively, and
calculating a first positive electrode thickness ratio RT_{P1}(=T_{P1}/T_{PC}), which is a ratio of T_{P1} to T_{PC};
determining a negative electrode first face-to-face predetermined line P1 on a negative electrode sheet to face the lower end part predetermined area of the positive electrode;
measuring a thickness T_{NC} of a negative electrode mixture layer at a center part of a negative electrode and a thickness T_{N1} of the negative electrode mixture layer at the negative electrode first face-to-face predetermined line P1, on the negative electrode sheet, respectively, and calculating a first negative electrode thickness ratio RT_{N1}(=T_{N1}/T_{N}c), which is a ratio of T_{N1} to T_{NC}; and
confirming whether a relationship between the first positive electrode thickness ratio RT_{P1} and the first negative electrode thickness ratio RT_{N1} satisfies Condition 1 below;
$$R {T}_{N 1} \geq ( R {T}_{P 1} / NP Ratio ) \times 100.1 \qquad [ Condition 1 ]$$
in the Condition 1, the NP Ratio is a the ratio value of negative electrode capacity to positive electrode capacity per unit area, and is a preset value.

17. The electrode sliding standards management method of claim 16, further comprising:
measuring a thickness T_{P2} of the positive electrode mixture layer at an upper end part predetermined area of the positive electrode, and
calculating a second positive electrode thickness ratio RT_{P2}(=T_{P2}/T_{PC}), which is a ratio of T_{P2} to T_{PC};
determining a negative electrode second face-to-face predetermined line P2 to face the upper end part of the positive electrode in the negative electrode sheet;
measuring a thickness T_{N2} of the negative electrode mixture layer at the second negative electrode face-to-face predetermined line P2, and
calculating a second negative electrode thickness ratio RT_{N2}(=T_{N2}/T_{NC}), which is a ratio of T_{N2} to T_{NC}; and
determining whether a relationship between the second positive electrode thickness ratio RT_{P2} and the second negative electrode thickness ratio RT_{N2} satisfies Condition 2 below;
$$R {T}_{N 2} \geq ( R {T}_{P 2} / NP Ratio ) \times 100.1 \qquad [ Condition 2 ]$$
wherein in the Condition 2, the NP Ratio is a ratio value of negative electrode capacity to positive electrode capacity per unit area and is a present value.

18. The electrode sliding standards management method of claim 16,
wherein
in determining the negative electrode first face-to-face predetermined line,
the negative electrode first face-to-face predetermined line P1 is determined as an imaginary line connecting points spaced apart by a length L1 of the negative electrode shoulder line part plus a planar spacing G1 of the positive electrode and negative electrode along the width direction from the boundary line of the negative electrode mixture applied part and the negative electrode mixture non-applied part.

19. The electrode sliding standards management method of claim 16,
wherein,
in determining the negative electrode second face-to-face predetermined line,
the negative electrode second face-to-face predetermined line P2 is determined as an imaginary line connecting points spaced apart by a full-length direction length C of the positive electrode along a width direction from the negative electrode first face-to-face predetermined line P1.
